(19) United States
(12) Patent Application Publication
(10) Pub. No.: US 2003/0037021 A1
(43) Pub. Date: Feb. 20, 2003

(54) JavaScript in a non-JavaScript environment

(76) Inventors: Prasad Krothappalli, San Jose, CA (US); Ravi Pachipala, Fremont, CA (US); Mahesh Rangamani, Mountain View, CA (US); Amitabh Sinha, Redwood City, CA (US); Roopak Parikh, San Jose, CA (US); Ritesh Adval, San Jose, CA (US); Mark Tracy, Union City, CA (US)

Correspondence Address: PIILLSBURY WINTHROP LLP, Intellectual Property Department, 1600 Tysons Boulevard, McLean, VA, 22102, US

(21) Appl. No.: 09/765,080

(22) Filed: Jan. 17, 2001

(51) Int. Cl. G06F 7/00

(52) U.S. Cl. 707/1

(57) ABSTRACT

A method for providing an enhanced experience associated with a scripting language on a device that does not have the ability to run scripts. The method includes receiving at an application server a script, and sending new information based on executing the script to a device.

### FIELD

This invention relates to event handling on computing devices, and more specifically, to event handling on computing devices that do not support JavaScript.

### BACKGROUND

JavaScript is a platform-independent, event-driven, interpreted programming language developed by Netscape Communications Corp. and Sun Microsystems. Additionally, it is a compact scripting language useful for developing client and server internet applications that work in combination with an internet browser. Examples of browsers include Netscape Navigator™, and Microsoft Internet Explorer™, among many others. An internet browser can interpret JavaScript statements embedded directly in a hypertext markup language (HTML) document (e.g., web page) and execute an application to perform functions in response to the occurrence of an event. For example, in a client application for a browser, JavaScript statements embedded in an HTML document can recognize and respond to user events such as mouse clicks, form input, and page navigation. One can write a JavaScript application to verify that users enter valid information into a form requesting a telephone number or zip code. Without any network transmission, an HTML document with embedded JavaScript can interpret the entered text and alert the user with a message dialog if the input is invalid. One can use JavaScript to perform an action (such as play an audio file, execute an applet, or communicate with a plug-in) in response to the user opening or exiting a page, or can change choices (e.g., states vs. provinces) available to a user in response to a previous selection (e.g., USA vs. Canada).

JavaScript is useful for adding interactivity to the internet because scripts can be embedded in the HTML of web pages simply by enclosing code in a <SCRIPT></SCRIPT> tag pair. Since all modern browsers can interpret JavaScript, a user is provided with an enhanced experience, in response to an event, without any network transmission.

Unfortunately, many devices that allow a user to navigate the internet do not have the facility to interpret and execute JavaScript. Examples of devices that may not have the ability to interpret and execute JavaScript include, but are not limited to, cellular phones, personal digital assistants (PDAs), regular public switched telephone network (PSTN) telephones, and palm personal computers.

Since these devices do not support JavaScript, it is desirable to provide a mechanism for allowing a user of such a device to have the enhanced experience provided by JavaScript even though the device does not support JavaScript.

### SUMMARY

A method for providing an enhanced experience associated with a scripting language on a device that does not have the ability to run scripts is described. The method includes receiving at an application server a script, and sending new information based on executing the script to a device.

### DESCRIPTION OF THE DRAWINGS

The present invention is illustrated by way of example, and not limitation, in the figures of the accompanying drawings in which like references denote similar elements, and in which:

FIG. 1 illustrates a block diagram of a system in which wireless and wired devices communicate with an application server;

FIG. 2 illustrates a screen display that may be rendered on the screen of a user device;

FIG. 3 illustrates a process of providing the enhanced experience of scripts to a device that does not support scripts, in accordance with one embodiment of the present invention;

FIG. 4 illustrates a process of providing the enhanced experience of scripts to a device that does not support scripts, in accordance with an alternative embodiment of the present invention; and

FIG. 5 illustrates a block diagram of an application server, in accordance with one embodiment of the present invention.

### DETAILED DESCRIPTION

Methods and apparatus for providing an enhanced experience associated with a scripting language on a device that does not have the ability to run scripts are described. In the following description, for purposes of explanation, numerous specific details are set forth in order to provide a thorough understanding of the present invention. It will be evident, however, to one skilled in the art that the present invention may be practiced in a variety of communication systems, especially wireless application protocol systems, and communications devices, especially telephones, without these specific details. In other instances, well-known operations, steps, functions and devices are not shown in order to avoid obscuring the invention.

Parts of the description will be presented using terminology commonly employed by those skilled in the art to convey the substance of their work to others skilled in the art, such as protocol, gateway, render, store, interpret, and so forth. Also parts of the description will also be presented in terms of operations performed through the execution of programming instructions or initiating the functionality of some electrical component(s) or circuitry, using terms such as, performing, sending, processing, transmitting, configuring, and so on. As well understood by those skilled in the art, these operations take the form of electromagnetic, electrical, magnetic, or optical signals capable of being stored, transferred, transmitted, combined, and otherwise manipulated through electrical or electromechanical components.

Various operations will be described as multiple discrete steps performed in turn in a manner that is most helpful in understanding the present invention. However, the order of description should not be construed as to imply that these operations are necessarily performed in the order that they are presented, or even order dependent. Lastly, repeated usage of the phrases “in one embodiment,” “an alternative embodiment,” or an “alternate embodiment” does not necessarily refer to the same embodiment, although it may.

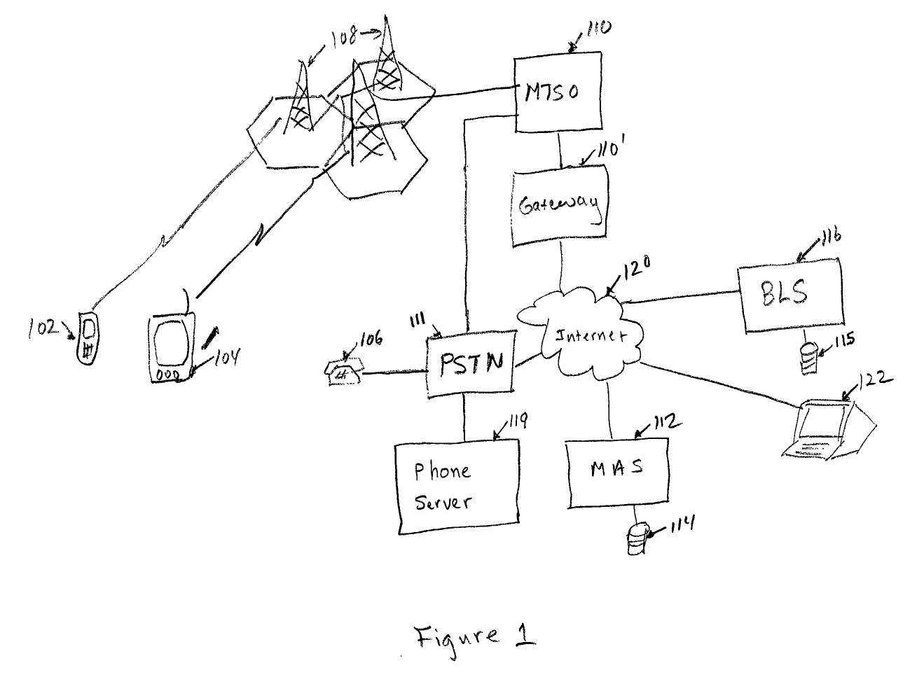

FIG. 1 illustrates a block diagram of a system in which wireless and wired devices communicate with an application server. System 100 includes mobile telephone 102, personal digital assistant (PDA)104, telephone 106, cellular stations 108, mobile telephone switching office (MTSO) 110, gateway 110′, public switched telephone network switching office 11, mobile application server 112, storage 114, business logic server 116, internet 120, and computer 122. PDA 104 communicates with application server 112 by first setting up a data link with cellular station 108. Cellular station 108 relays to MTSO 110 data received from PDA 104. MTSO 110 in turn sends the data to gateway 110′. MTSO is an interface to the public switched telephone network for mobile phones making telephone calls to or receiving calls from telephones such as telephone 106. MTSO 110 directs internet traffic to and from gateway 110′ which is an interface between the wireless network and internet 120. Server 112 communicates with business logic server 116 which provides in various embodiments services including, but not limited to, retrieving stock quotes and airline flight information or sport scores, trading stock, buying and selling goods.

Business logic server 116 generates visual information such as documents providing product offerings, query pages for information such as flight or stock quotes, and pages for procuring other services. The documents can be in hypertext markup language (HTML) or another page description language. The pages can be rendered on a screen of a device by a browser. In one embodiment, business logic server 116 is unable to communicate directly with PDA 104, and telephone 102 because it puts JavaScript into its documents and PDA 104 and telephone 102 are not able to execute JavaScript.

Many telephones, palm computers, PDAs are not able to execute JavaScript because, for example, the browser on the device does not execute JavaScript or there is no browser on the device to begin with as in telephone 106. Since JavaScript provides an enhanced user experience and server 116 may have a large user base which communicates with server 116 using JavaScript enabled browsers, it is desirable to allow server 116 to continue producing documents with JavaScript while also giving users of PDA 104 and telephones 102 and 106 the enhanced experience afforded by JavaScript. The present invention provides a mechanism for allowing PDAs, telephones and other devices that may not support JavaScript the enhanced experience afforded by JavaScript enabled browsers.

Business logic server 116 is also unable to communicate directly with PDA 104, and telephones 102 and 106 because it generates documents that cannot be rendered on the tiny screens of PDA 104 and telephone 102 or the screenless telephone 106. Because PDA 104, telephone 102 and 106 are unable to render the documents generated by server 116, they are referred to herein as reduced content devices.

Server 112 has a software suite that permits the HTML documents to be reformatted, reduced, or represented in a different manner (for example audibly) such that the services indicated above can be provided despite the small screens of PDA 104 and telephone 102 and the lack of a screen in telephone 106. Mechanisms for extracting data from an HTML document and representing it in a manner suitable for reduced content devices is the subject of co-pending patent application “Method for Converting Two-dimensional Data into a Canonical Representation” with Ser. No. 09/394,120, filed on Sep. 10, 1999, and co-pending patent application “Method for Customizing and Rendering of Selected Data Fields” with Ser. No. 09/393,133, filed on Sep. 10, 1999.

Server 112 may represent information from an HTML document received from server 116 audibly rather than visually to a user of telephones 102 and 106. Server 112 presents information from the document in voice XML or some other language that handles voice. Server 112 sends the voice XML to phone server 119 which provides text to speech conversion. When telephone 102 is communicating through audible signals with server 112, the communication path is through stations 108, MTSO 110, PSTN 111, and server 119. Alternatively, telephone 102 can communicate in a data mode with server 112; in which case, the communication path is through stations 108, MTSO 110, and gateway 110′. When telephone 106 is communicating through audible signals with server 112, the communication path runs through PSTN 111 and server 119.

A user responds to server 112 and server 116 by pressing a key to generate a dual tone multi-frequency (DTMF) tone or speaking into the telephone's microphone. Alternatively, server 112 may provide only a portion of a document at a time on telephone 102 or PDA 104. A user would navigate from one portion of the document to another by inputting a signal to change from one portion of the document to another, whether by pressing a key, touching an area of the screen, or by some other method. Furthermore, by the aforementioned methods, a user can respond to queries and choices sent from server 112 and server 116.

In an alternative embodiment PDA 104 is a handheld personal computer. Handheld personal computers tend to have small keyboards instead of a touch screen.

Before describing the mechanism by which the enhanced experience afforded by JavaScript is provided to devices that are unable to execute JavaScript, the operation of system 100 will be described. In one embodiment, telephone 102 and PDA 104 communicate in accordance with wireless access protocol (WAP). WAP is an application environment and a group of protocols that define access of wireless devices to internet services. The application environment is uniform and does not depend on the underlying protocol for the communications air link. WAP is implemented or will be implemented on global system for mobile communications (GSM), interim standard (IS)-136, time-division multiple access (TDMA), personal communications service (PCS), and code division multiple access (CDMA), among other schemes. The present invention can be practiced with any application environment and communications protocols.

A WAP request from telephone 102 can be an hypertext protocol (HTTP) request including a URL such as http://www.services.everypath.com. Telephone 102 converts the text URL into a binary wireless session protocol (WSP) request. WSP is a protocol layer that defines efficient exchange of data between applications. Depending on the particular embodiment, the binary request is transmitted to cellular station 108 in accordance with one of the air link protocols indicated above. Station 108 forwards the binary request to MTSO 110. MTSO is the interface to the public switched telephone network for mobile phones making telephone calls to or receiving calls from telephones such as telephone 106. MTSO 110 directs internet traffic to and from gateway 110′ which is an interface between the wireless network and internet 120. Gateway 110′ converts the binary request to an HTTP request and sends the request to server 112 via internet 120.

To procure a service provided by server 116, a user using PDA 104 (or telephones 102 and 106) instructs the device to send the URL for the website providing the service to server 116 by way of stations 108 and MTSO 110. The description below of the procurement of a service provided by server 116 is provided in the context of PDA 104 procuring the service. However, it should be appreciated that the description is equally applicable to procurement of service by telephone 102 or telephone 106.

Since server 116 communicates with HTML that includes JavaScript, server 116 cannot communicate adequately with PDA 104. Consequently, it informs PDA 104 that it should direct its requests for service to server 112 by sending PDA 104 the URL for the website providing the service on server 112. Having server 116 redirect PDA 104 to server 112 is referred to herein as redirection. Redirection is the subject of co-pending application “Method And Apparatus For Using A Known Address To Gain Access To A Service Provider Having An Unknown Address” with Ser. No. ______ filed on Jan. 17, 2001. PDA 104 then sends the URL received from server 116 to MTSO 110 by way of stations 108. MTSO 110 then forwards the URL to server 112.

Server 112 recognizes from the URL that PDA 104 is requesting a document that is associated with a particular service provided by server 116. Consequently, server 112 requests that server 116 send to it the HTML document. The document that is requested may include JavaScript. Since telephone 102 and PDA 104 do not communicate using HTML, server 112 extracts data from the HTML document and represents it in a reduced content language that is understood by telephone 102 and PDA 104, such as WML, HDML, or Palm HTML. Mechanisms for extracting data from an HTML document and representing it in a manner suitable for reduced content devices is the subject of co-pending patent application “Method for Converting Two-dimensional Data into a Canonical Representation” with Ser. No. 09/394,120, filed on Sep. 10, 1999, and co-pending patent application “Method for Customizing and Rendering of Selected Data Fields” with Ser. No. 09/393,133, filed on Sep. 10, 1999.

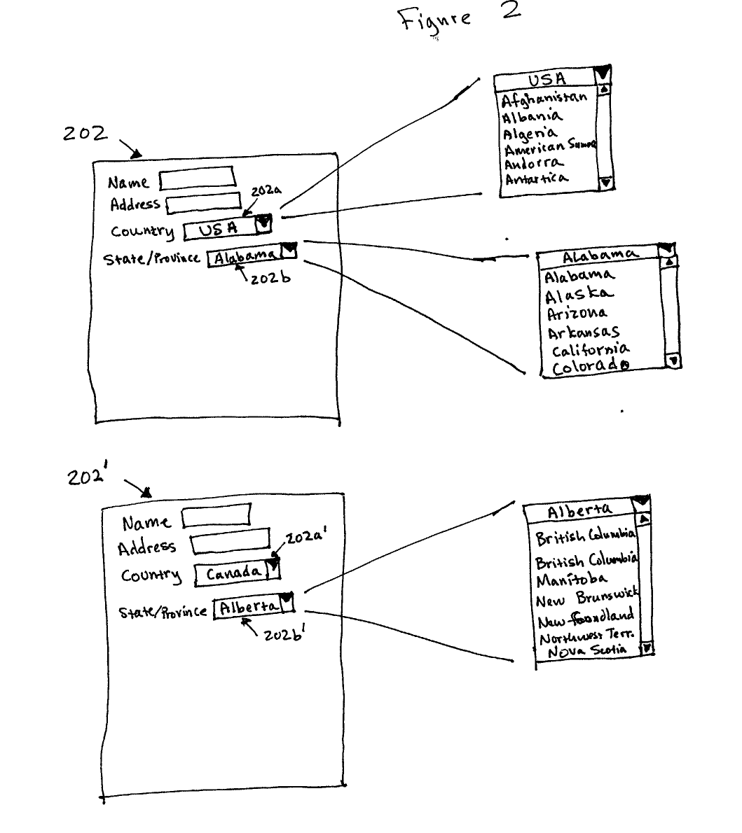

FIG. 2 illustrates a screen display that may be rendered on a screen of a device. Display 202 is a shipping address form that requests a user to enter the user's shipping address. Display 202 has a corresponding HTML document which includes JavaScript. Display 202 has drop down menu 202a for selecting the user's country and a drop down menu 202b for sections of the user's country. For example, some countries are divided into sections referred to as ‘states’ other countries are divided into sections referred to as provinces. Each country has its own associated states or provinces. The default selections in drop down menu 202b are the states of the United States of America (USA). In an alternative embodiment, other default selections are possible. When the user makes a selection from the country drop down menu JavaScript in the HTML document that corresponds to display 202 is executed. If the user selected a country other than the USA, execution of the JavaScript causes the selections in the drop down menu 202b to be changed based on the user's country choice. Screen 202′ shows the shipping form after the user selected Canada from menu 202a. Drop down menu 202a′shows the user's selection of Canada. Due to the execution of the JavaScript drop down menu 202b′ has the provinces of Canada rather than the states of the USA. It should be appreciated that one of ordinary skill in the art would be able to write JavaScript which would provide the functionality described above.

The above example shows how JavaScript is useful in a data input environment which does not allow easy entry of data. For example, instead of having to type in the name of a state or province, the user can simply select a name from a drop down menu once a country selection is made. This use of JavaScript is particularly important in devices which do not allow easy entry of data such as PDAs, cellular phones, palm computers, and other compact or mobile devices. Unfortunately, many of these devices do not support browsers that are able to execute JavaScript. Consequently, the enhanced experienced afforded by JavaScript is not conventionally possible for these devices. The present invention provides a method and apparatus for allowing telephones, PDAs and other devices that do not support JavaScript to provide to the user the enhanced experience afforded by JavaScript.

While one example of how JavaScript can be used was described above, it should be appreciated that there are many ways for using JavaScript, the limit essentially being a programmer's imagination. The present invention is not limited to any particular application of using JavaScript, but, rather, encompasses any JavaScript application that can be made.

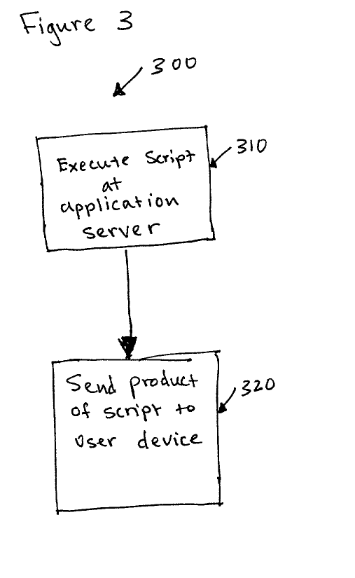

FIG. 3 illustrates a process of providing the enhanced experience of scripts to a device that does not support scripts, in accordance with one embodiment of the present invention. Process 300 can be performed by an application server such as server 112 on behalf of a device such as PDA 104 or telephone 102. Process 300 includes execution 310 of a script at an application server on behalf of a device that does not support scripts. The product of executing the script is sent 320 to the device. The product of executing the script includes, but is not limited to, an instruction to the device to play an audio file, an instruction to the device to replace old, default information in a form with new, substitute information, an instruction to the device to generate a pop-up window requesting additional information, an instruction to change colors of figures rendered on the display of the device. Instruction is used herein to refer, in the appropriate context, to both instruction and data.

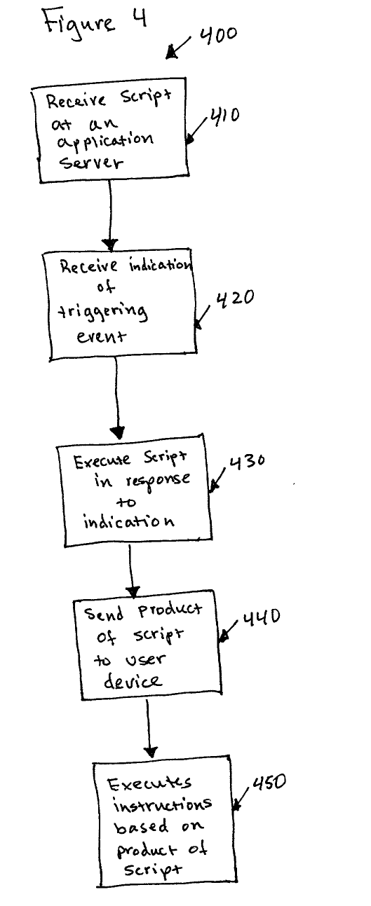

FIG. 4 illustrates a process of providing the enhanced experience of scripts to a device that does not support scripts, in accordance with an alternative embodiment of the present invention. Process 400 can be performed by an application server such as server 112 and a device such as PDA 104 or telephone 102. Process 400 includes receipt 410 of a script at an application server. An indication of a triggering event is later received 420 at the application server from the device. A triggering event includes, but is not limited to, mouse clicks, form input, and page navigation. The application server executes 430 the script in response to the indication. The product of the script is sent 440 to the device. Depending on the product of the script, the device executes 450 one of the instructions described above, providing the user of the device with the enhanced experience afforded by JavaScript even though the device does not execute JavaScript.

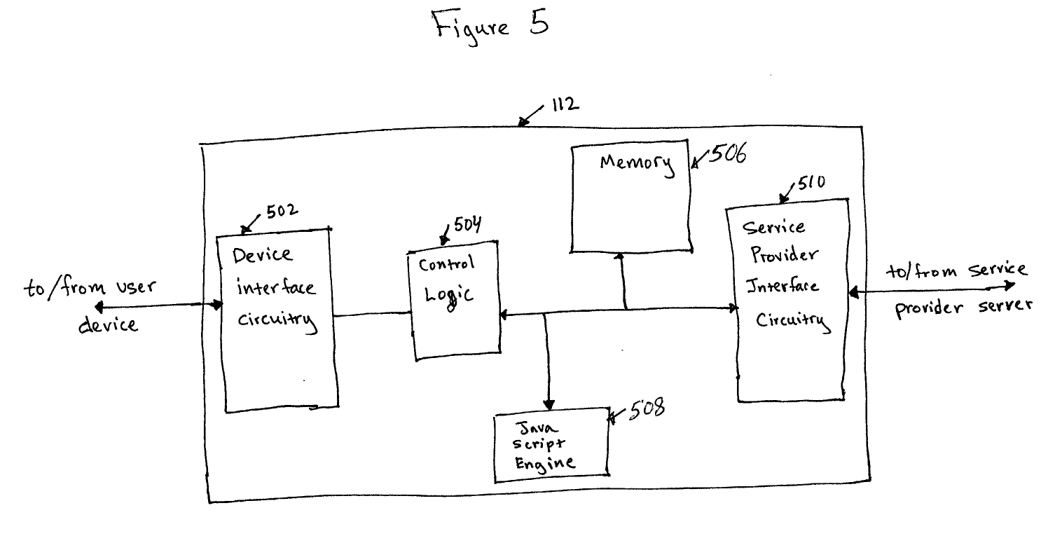

FIG. 5 illustrates a block diagram of an application server, in accordance with one embodiment of the present invention. Server 112 includes device interface circuitry 502, control logic 504, memory 506 containing application code, and a JavaScript engine 508 and service provider interface circuitry 510. As will be described below, JavaScript engine 508 executes the JavaScript on behalf of PDA 104 and sends the product of the execution to PDA 104. According to one embodiment a JavaScript engine made by Nombas, Inc. of Malden, Ma. is used. Other JavaScript engines are also available and can be used.

According to one embodiment of the present invention, device interface circuitry receives an HTTP request from gateway 110′. The HTTP request sent from gateway 110′ is based on a wireless application protocol request that gateway 110′ received from telephone 102. Circuitry 502 receives from a device such as PDA 104 or telephone 102 a URL which indicates that a user of the device wants to procure a service provided by server 116. Based on the URL, control logic 504 requests server 116 through circuitry 510 to send the document associated with the URL. When the document is received, control logic 504 based on instructions of application code in memory 506 sends to the device instructions that can be used to visually or audibly render information at the device. If the document includes JavaScript, control logic 504 stores the JavaScript in memory 506. If the JavaScript is to be executed when the document is received without waiting for a triggering event to happen, control logic 504 provides the JavaScript to engine 508 which executes the JavaScript and provides the product of the JavaScript to control logic 504. Control logic 504 in turn sends the product of the JavaScript to the device via circuitry 502. The device uses the product of the JavaScript to execute a variety of instructions, as described above with reference to FIGS. 3 and 4. If the JavaScript is to be executed when an indication of a triggering event is received from the device, in one embodiment, engine 508 does not execute the JavaScript until the indication is received at circuitry 502. After the JavaScript is executed by engine 508, the product of the execution is provided to control logic 504 which sends the product to the device via circuitry 502. The device uses the product of the JavaScript to execute a variety of instructions, as described above with reference to FIGS. 3 and 4.

Thus, methods and apparatus for providing an enhanced experience associated with a scripting language on a device that does not have the ability to run scripts have been described. Although the present invention has been described with reference to specific exemplary embodiments, it will be evident to one of ordinary skill in the art that various modifications and changes may be made to these embodiments without departing from the broader spirit and scope of the invention as set forth in the claims. Accordingly, the specification and drawings are to be regarded in an illustrative rather than a restrictive sense

We claim

1. A method for providing an enhanced experience associated with a scripting language on a device that does not have the ability to run scripts, the method comprising:
executing at an application server a script; and
sending new information based on executing the script to a device.

2. The method of claim 1, further comprising receiving from a device an indication of a triggering event.

3. The method of claim 2, executing at the application server the script includes executing at the application server the script in response to the triggering event

4. The method of claim 3, further comprising receiving at an application server a document including a script.

5. The method of claim 4, further comprising replacing at the device old information with the new information.

6. The method of claim 4, further comprising rendering visually the new information on a display of the device.

7. The method of claim 4, further comprising, audibly rendering the new information at the device.

8. The method of claim 4, wherein the triggering event is entry of user supplied information at the device.
